(19) United States
(12) Patent Application Publication
(10) Pub. No.: US 2008/0042420 A1
(43) Pub. Date: Feb. 21, 2008

(54) Clamping Apparatus for Adjustable Steering Column for a Vehicle

(76) Inventors: Mohammed Ali, Coventry (GB); Seiichi Moriyama, Gunma (JP)

Correspondence Address: MILES & STOCKBRIDGE PC, 1751 PINNACLE DRIVE, SUITE 500, MCLEAN, VA, 22102-3833, US

(21) Appl. No.: 10/527,167

(22) PCT Filed: Sep. 9, 2003
(86) PCT No.: PCT/GB03/03903

§ 371 Date: Dec. 28, 2005

(30) Foreign Application Priority Data
Sep. 10, 2002 (GB) 0220950.0

(51) Int. Cl. B62D 1/184

(52) U.S. Cl. 280/775; 74/493

(57) ABSTRACT

A clamping apparatus for an adjustable steering column for a vehicle includes at least two, relatively slidable plates (1, 2) that can be clamped relatively to one another. More than two plates can be provided to form a pack of plates. Alternate plates have relatively slidable, clamping surfaces that can contact one another, the respective clamping surfaces of the two plates being made of material of different hardnesses. In use, the softer material of one of the plates will deform due to the rubbing of the material of the harder plate and this increases stiction and friction, thereby converting friction into a sheer stress load.

This invention relates to a clamping apparatus for an adjustable steering column for a vehicle. Space factors are often needed to be taken into account when constructing steering column assemblies, particularly in the region of the driver of a vehicle, where steering column clamping mechanisms are generally located.

According to the present invention, there is provided a clamping apparatus for an adjustable steering column for a vehicle, the clamping apparatus including at least two, relatively slidable plates that can be clamped relatively to one another, the two plates having relatively slidable, clamping surfaces that contact one another, the respective clamping surfaces of the two plates being made of material of different hardnesses.

One of the plates may be used in connection with reach adjustment of the steering column and the other plate may be used in connection with rake adjustment of the steering column. However, both plates could form part of the reach adjustment or part of the rake adjustment apparatus.

More than one plate of each type may be provided to form a pack of clamping plates. In such a case, it is intended that alternate plates will be of different hardnesses.

One of the plates may be made of a metal such as mild steel and the other plate can be made of a metal such as mild aluminium or aluminium alloy.

The invention also extends to an adjustable steering column for a vehicle incorporating a clamping apparatus essentially as defined above.

Of course, the invention also extends to a vehicle incorporating such an adjustable steering column, which may be rake and/or reach adjustable.

For a better understanding of the invention and to show how the same may be carried into effect, reference will now be made, by way of example, to the accompanying drawings, in which:

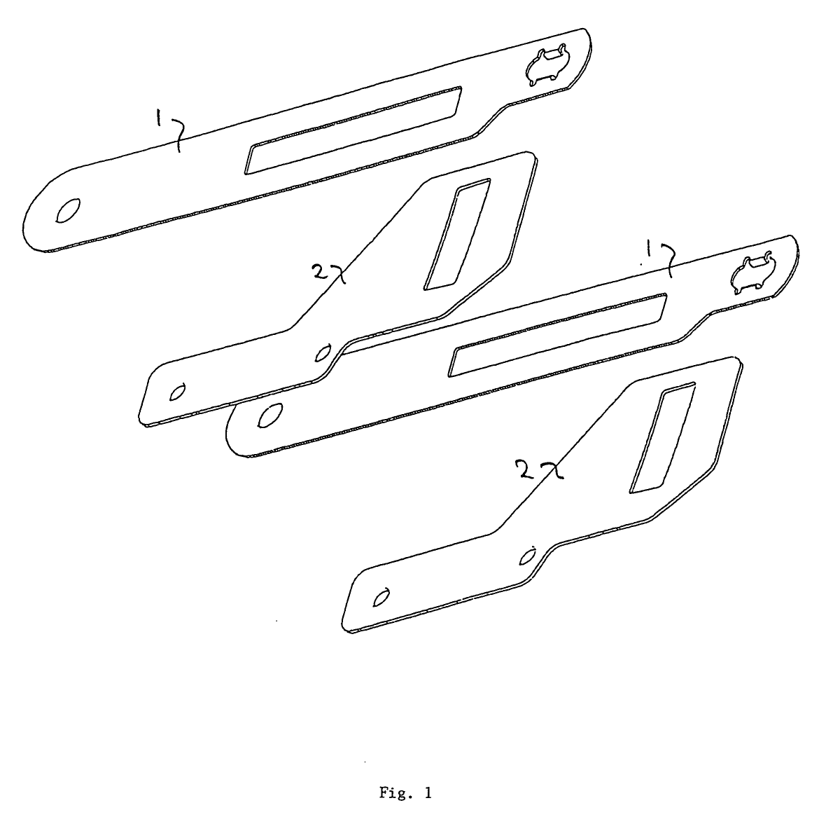

FIG. 1 is a diagrammatic exploded perspective view of part of a clamping apparatus for an adjustable steering column for a vehicle; and

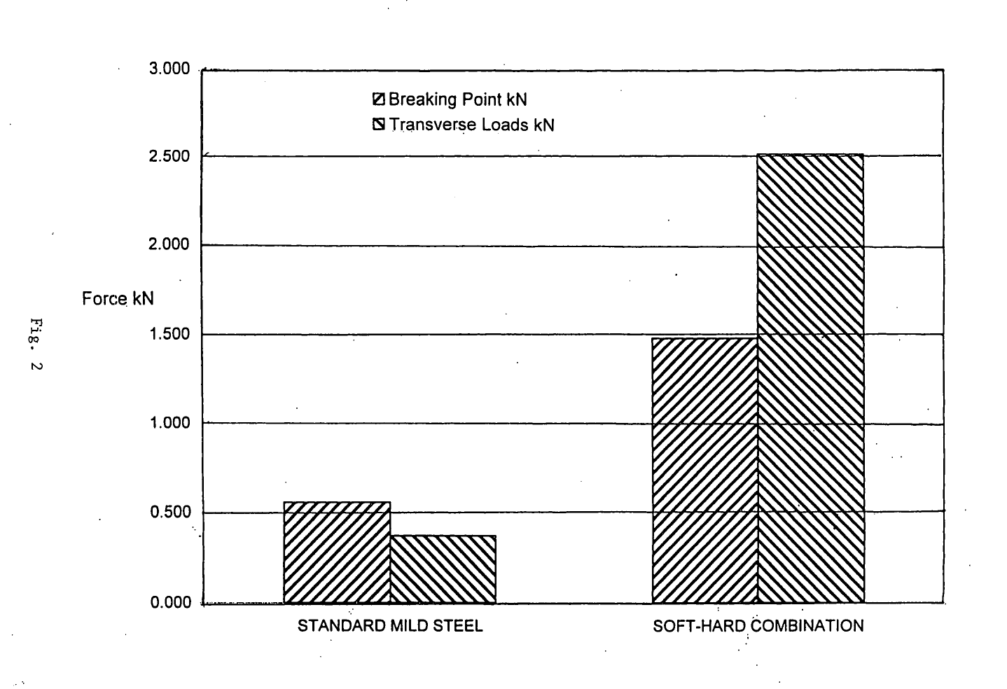

FIG. 2 is a chart comparing the use of clamping plates made of standard mild steel alone with clamping plates made of a combination of soft and hard materials, such as alternate plates being made of mild steel and mild aluminium, respectively.

Referring to the drawings, FIG. 1 shows a pair of clamping plates 1, which in the example shown are used for reach adjustment of a steering column (not shown) in combination with a pair of clamping plates 2 which in the example shown are used for rake adjustment of the steering column. As is clearly seen, the plates 1 and 2 are alternately disposed relatively to one another.

To provide the required soft-hard combination, the plates 1 are, for example, made of a comparatively soft material, whilst the plates 2 are made of a comparatively harder material.

When the plates are clamped together to form a clamping pack, the oppositely-facing surfaces of the plates naturally contact one another. Any number of plates can be provided. Normally, one pack of plates would be provided on one side of a steering column and another would be provided on the opposite side of the column.

When the plates are in their clamped condition, the surfaces of the tougher material on the plates 2 contact the surfaces of the softer material of the plates 1 and this creates increased friction through the clamping system and as a result of the differences in the hardness of the surfaces.

When the suggested material used is mild aluminium with mild steel between the reach and rake adjustment plates, when the plates are in a clamped condition during vehicle crash the plates begin relative sliding movement and the aluminium begins to shear on the surface of the plate 1 due to the action of the tougher mild steel material of the plate 2. This has the tendency to increase or provide a build-up of aluminium material, which in turn increases the clamping load. This in turn adds to the friction and stiction performance as illustrated in the chart shown in FIG. 2.

The table shown below provides some figures that have been obtained under test.

| | | Breaking | Transverse |
|---|---|---|---|
| | | Point | Loads |
| | | kN | kN |
| SOFT-HARD | STANDARD MILD STEEL | 0.554 | 0.370 |
| COMBINATION | SOFT-HARD | 1.480 | 2.520 |
| | COMBINATION | | |

It will be appreciated that with the use of soft and hard materials for the plates 1 and 2, the number of and even thickness of the reach and rake plates can be modified, especially since a friction coating on the plates- need not be provided. This means that the packaging size of the clamping mechanism can be reduced as can be the weight of the mechanism.

1. A clamping apparatus for an adjustable steering column for a vehicle, the clamping apparatus including at least two, relatively slidable plates that can be clamped relatively to one another, the two plates having relatively slidable, clamping surfaces that contact one another, the respective clamping surfaces of the two plates being made of material of different hardnesses.

2. An apparatus according to claim 1, wherein one of the plates is used in connection with reach adjustment of the steering column.

3-9. (canceled)

10. An apparatus according to claim 1, wherein one of the plates is used in connection with rake adjustment of the steering column.

11. An apparatus according to claim 2, wherein one of the plates is used in connection with rake adjustment of the steering column.

12. An apparatus according to claim 1, wherein one of the plates is made of mild steel.

13. An apparatus according to claim 2, wherein one of the plates is made of mild steel.

14. An apparatus according to claim 10, wherein one of the plates is made of mild steel.

15. An apparatus according to claim 1, wherein one of the plates is made of mild aluminum or aluminum alloy.

16. An apparatus according to claim 2, wherein one of the plates is made of mild aluminum or aluminum alloy.

17. An apparatus according to claim 10, wherein one of the plates is made of mild aluminum or aluminum alloy.

18. An apparatus according to claim 12, wherein one of the plates is made of mild aluminum or aluminum alloy.

19. An adjustable steering column for a vehicle incorporating a clamping apparatus according to claim 1.

20. An adjustable steering column for a vehicle incorporating a clamping apparatus according to claim 2.

21. An adjustable steering column for a vehicle incorporating a clamping apparatus according to claim 10.

22. An adjustable steering column for a vehicle incorporating a clamping apparatus according to claim 12.

23. An adjustable steering column for a vehicle incorporating a clamping apparatus according to claim 15.

24. An adjustable steering column according to claim 19, which is rake and/or reach adjustable.

25. A vehicle incorporating an adjustable steering column according to claim 19.

26. A vehicle incorporating an adjustable steering column according to claim 24.
